(19) United States
(12) Patent Application Publication
(10) Pub. No.: US 2022/0366249 A1
(43) Pub. Date: Nov. 17, 2022

(54) METHOD AND DEVICE FOR ADJUSTING DEEP LEARNING NETWORK, SERVER, AND STORAGE MEDIUM

(71) Applicant: Shenzhen Corerain Technologies Co., Ltd., Shenzhen (CN)

(72) Inventors: Wei Zou, Shenzhen (CN); Chao Xiong, Shenzhencn (CN); Xinyu Niu, Shenzhen (CN); Kuenhung Tsoi, Shenzhen (CN)

(73) Assignee: Shenzhen Corerain Technologies Co., Ltd., Shenzhen (CN)

(21) Appl. No.: 17/771,035

(22) PCT Filed: Oct. 22, 2019
(86) PCT No.: PCT/CN2019/112463

§ 371 Date: Apr. 22, 2022

(51) Int. Cl. G06N 3/08; G06K 9/62

(52) U.S. Cl. CPC G06N 3/08; G06K 9/6289; G06K 9/6296

(57) ABSTRACT

Provided are a method and device for adjusting a deep learning network, a server and a storage medium. The method includes acquiring an initial data streaming computation graph that includes first operators for computing initial constant expressions; and obtaining a target data streaming computation graph according to parameters in the initial constant expressions. The target data streaming computation graph includes a second operator and is used for controlling a deep learning acceleration chip to perform data computation. The granularity of the second operator is larger than the granularity of a first operator to enable an adjustment of the amount of computation of the deep learning acceleration chip.

### TECHNICAL FIELD

Embodiments of the present application relate to the field of deep learning technology, for example, a method and device for adjusting a deep learning network, a server and a storage medium.

### BACKGROUND

With the development of data streaming architectures, the optimization of data structure is becoming more and more important in improving the efficiency of a data streaming architecture.

The current data structure of a deep learning network is usually designed for the instruction set architectures. An instruction set architecture is characterized in that its data structure can be correspondingly split into single instruction forms, the granularity of a computation unit is small, and computation units may be combined arbitrarily. However, compared with an instruction set architecture, the granularity of the computation unit of a data structure running on a data streaming architecture is larger, and the combination of computation units supported by the data structure is also limited. Moreover, the corresponding form of the data structure is a data path, not an instruction unit. One data path is often composed of multiple complex computation units. To solve the optimization problem of the data structure of a data streaming architecture, researchers have studied a general data structure design based on a data streaming architecture.

However, the general data structure design based on the data streaming architecture is limited by the design of the data streaming architecture. Thus, the computation efficiency is low in the general data streaming data structure design.

### SUMMARY

Embodiments of the present application provide a method and device for adjusting a deep learning network, a server and a storage medium to achieve the effect of improving the computation efficiency of deep learning networks in the data streaming architecture.

The embodiments of the present application provide a method for adjusting a deep learning network. The method includes the steps below.

An initial data streaming computation graph that includes first operators for computing initial constant expressions is acquired.

A target data streaming computation graph is obtained according to the parameters in the initial constant expressions. The target data streaming computation graph includes a second operator and is used for controlling a deep learning acceleration chip to perform computation. The granularity of the second operator is larger than the granularity of a first operator to enable an adjustment of the amount of computation of the deep learning acceleration chip.

The embodiments of the present application provide a device for adjusting a deep learning network. The device includes an acquisition module and an optimization module.

The acquisition module is configured to acquire an initial data streaming computation graph that includes first operators for computing the initial constant expressions.

The optimization module is configured to obtain a target data streaming computation graph according to parameters in the initial constant expressions. The target data streaming computation graph includes the second operator and is used for controlling the deep learning acceleration chip to perform the data computation. The granularity of the second operator is larger than the granularity of a first operator to enable an adjustment of the amount of computation of the deep learning acceleration chip.

The embodiments of the present application provide a server that includes one or more processors and a storage device configured to store one or more programs.

The one or more programs, when executed by the one or more processors, cause the one or more processors to perform the method for adjusting a deep learning network according to any embodiment of the present application.

The embodiments of the present application provide a computer-readable storage medium storing a computer program which, when executed by a processor, causes the processor to perform the method for adjusting a deep learning network according to any embodiment of the present application.

### BRIEF DESCRIPTION OF DRAWINGS

FIG. 1 is a flowchart of a method for adjusting a deep learning network according to embodiment one of the present application.

FIG. 2 is a flowchart of another method for adjusting a deep learning network according to embodiment two of the present application.

FIG. 3 is a flowchart of another method for adjusting a deep learning network according to embodiment two of the present application.

FIG. 4 is a diagram illustrating the structure of a device for adjusting a deep learning network according to embodiment three of the present application.

FIG. 5 is a diagram illustrating the structure of a server according to embodiment three of the present application.

### DETAILED DESCRIPTION

The present application is described hereinafter in conjunction with drawings and embodiments. The embodiments described below are merely intended to explain but not to limit the present application. For ease of description, only part, not all, of the structures related to the present application are illustrated in the drawings.

Some of the exemplary embodiments are described as processing or methods depicted in flowcharts. Although the flowcharts describe a plurality of steps as sequential processing, many steps herein may be implemented concurrently, coincidently or simultaneously. Additionally, the sequence of a plurality of steps may be rearranged. Processing may be terminated when a plurality of steps are completed, but may further have additional steps not included in the drawings. The processing may correspond to a method, a function, a procedure, a subroutine, a subprogram or the like.

The terms “first”, “second” and the like may be used herein to describe a plurality of directions, actions, steps, elements or the like, but these directions, actions, steps or elements are not limited by these terms. These terms are merely used for distinguishing one direction, action, step or element from another direction, action, step or element. For example, without departing from the scope of the present application, the granularity of a first operator may be referred to as the granularity of a second operator, and similarly, the granularity of the second operator may be referred to as the granularity of the first operator. Each of the granularity of the first operator and the granularity of the second operator is the granularity of an operator, but is not the granularity of the same operator. Terms like “first”, “second” and the like are not to be construed as indicating or implying relative importance or implicitly indicating the number of technical features as indicated. Thus, a feature defined as a “first” feature or a “second” feature may explicitly or implicitly include one or more of such features. As described herein, the term “plurality of” is defined as at least two, for example, two, three or the like, unless otherwise limited.

### Embodiment One

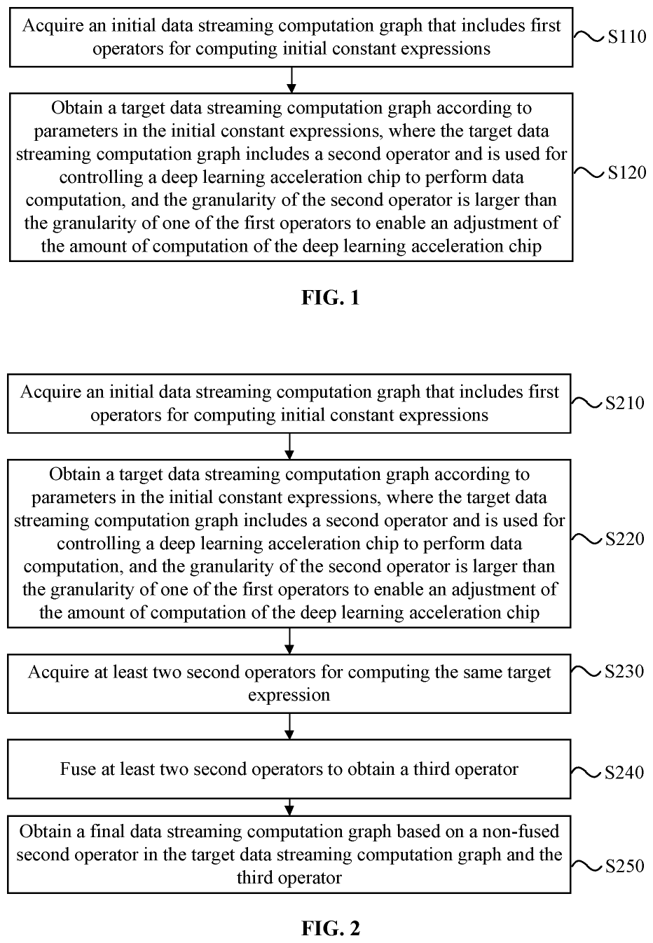

FIG. 1 is a flowchart of a method for adjusting a deep learning network according to embodiment one of the present application. This method may be applied to a scenario in which the deep learning network to be deployed on a data streaming architecture is optimized. This method may be executed by a device for adjusting a deep learning network. This device may be performed by software and/or hardware and may be integrated on a server.

As shown in FIG. 1, the method for adjusting a deep learning network provided by embodiment one includes the steps below.

In S110, an initial data streaming computation graph that includes first operators for computing initial constant expressions is acquired.

In this embodiment, a data streaming computation graph is a directed graph configured to represent data-driven computation. In the data streaming computation graph, each node represents one operator. The first operators refer to operators for computing the initial constant expressions in the initial data streaming computation graph. The initial data streaming computation graph refers to a data streaming computation graph that is not optimized. A constant expression refers to an expression that has only constant values. The initial constant expressions refer to constant expressions that need to be computed in the initial data streaming computation graph. In an embodiment, an initial constant expression may be a+b or a×b. The first operator is used for computing a+b or a×b. This is not limited in the present application.

In this embodiment, a and b are constants, for example, a is 1 and b is 2. The values of the constants are not limited in this present application.

In S120, a target data streaming computation graph is obtained according to parameters in the initial constant expressions. The target data streaming computation graph includes a second operator and is used for controlling a deep learning acceleration chip to perform data computation. The granularity of the second operator is larger than the granularity of the first operator to enable an adjustment of the amount of computation of the deep learning acceleration chip.

In this embodiment, the parameters refer to constant values in the initial constant expressions. For example, the initial constant expression is a×b, and values of parameter a and parameter b are constant. The target data streaming computation graph is obtained by the optimization of the parameters in the initial constant expression and is used for controlling the deep learning acceleration chip to perform the data computation.

In an embodiment, in the initial data streaming computation graph, only after two constant values are computed and one result is output, may the result be computed with another constant value. For example, there are three constants a, b and c. The final result to be computed is a×b+c. In the initial data streaming computation graph, a×b=n should be computed first, and then n+c is computed to output the result. The optimization of the parameters means that the parameters to be computed are computed at one time. For example, a×b+c is directly mapped onto the chip as an integrated operation to get the result. In this embodiment, the target data streaming computation graph includes the second operator used for computing an expression generated after the optimization of the parameters in the initial constant expressions. In an embodiment, the granularity of an operator affects the amount of computation of the deep learning network. Since computation after the optimization of the parameters is more complex, the granularity of the second operator is larger than the granularity of the first operator. In this manner, an adjustment of the amount of computation of the deep learning acceleration chip is enabled.

In the scheme of this embodiment of the present application, the initial data streaming computation graph that includes the first operators for computing the initial constant expressions is acquired; and the target data streaming computation graph is obtained according to the parameters in the initial constant expressions. With this scheme, the initial data streaming computation graph is optimized to the target data streaming computation graph. Moreover, the parameter computation of the data streaming computation graph in a neural network chip can be completed in one step. Thus, the on-chip computation time of the deep learning network is reduced. Additionally, the granularity of the second operator in the target data streaming computation graph is larger than the granularity of the first operator in the initial data streaming computation graph. Therefore, the amount of computation of the second operator in the target data streaming computation graph is also larger. In this manner, the problem of low computation efficiency of the deep learning network based on a data streaming architecture is solved, and the technical effect of improving the computation efficiency of the deep learning network is achieved.

### Embodiment Two

FIG. 2 is a flowchart of another method for adjusting a deep learning network according to embodiment two of the present application. This embodiment is described on the basis of the preceding scheme and is applied to a scenario in which the target data streaming computation graph is optimized. This method may be executed by a device for adjusting a deep learning network. This device may be performed by the software and/or hardware and may be integrated on the server.

As shown in FIG. 2, the method for adjusting a deep learning network provided by embodiment two of the present application includes the steps below.

In S210, the initial data streaming computation graph that includes the first operators for computing the initial constant expressions is acquired.

In this embodiment, the data streaming computation graph is a directed graph configured to represent the data-driven computation. In the data streaming computation graph, each node represents an operator. The first operators refer to the operator for computing the initial constant expressions in the initial data streaming computation graph. The initial data streaming computation graph refers to the data streaming computation graph that is not optimized. The constant expressions refer to the expressions that only have constant values. The initial constant expressions refer to constant expressions that need to be computed in the initial data streaming computation graph. In an embodiment, an initial constant expression may be a+b or a×b. The first operator is used for computing a+b or a×b. This is not limited in the present application. In this embodiment, a and b are constants, for example, a is 1 and b is 2. The values of the constants are not limited in this present application.

In S220, the target data streaming computation graph is obtained according to the parameters in the initial constant expressions. The target data streaming computation graph includes the second operator and is used for controlling the deep learning acceleration chip to perform the data computation. The granularity of the second operator is larger than the granularity of the first operator to enable an adjustment of the amount of computation of the deep learning acceleration chip.

In this embodiment, the parameters refer to constant values in the initial constant expressions. For example, the initial constant expression is a×b, and values of parameter a and parameter b are constant values. The target data streaming computation graph is obtained by the optimization of the parameters in the initial constant expressions and is used for controlling the deep learning acceleration chip to perform the data computation.

The second operator in the target data streaming computation graph is used for computing a target expression obtained based on the optimization of the parameters in the initial constant expressions. In an embodiment, in the initial data streaming computation graph, only after two constant values are computed and one result is output, may the result be computed with another constant value. For example, there are three constants a, b and c. The final result to be computed is a×b+c. In the initial data streaming computation graph, a×b=n should be computed first, and then n+c is computed to output the result. The initial constant expression may be a×b or n+c. The initial constant expression can only compute two parameters at a time. The target expression is obtained by the optimization of the parameters in the initial constant expressions. For example, the target expression is a×b+c, and parameters of the initial constant expressions are combined, where a, b and c are constant values.

The target expression may compute a plurality of constants at a time. For example, the computation result of a×b+c+d needs to be output. Initial constant expressions are a×b=n1, n1+c=n2 and n2+d=n3, and the result of n3 is finally output. The target expression is a×b+c+d=n3. After one time of computation, the result of n3 is directly output, and the computation efficiency is greatly improved.

Since the first operators are used for computing the initial constant expressions, and the second operator is used for computing the target expression obtained by the optimization of the initial constant expressions, the second operator is obtained by the fusion of at least two first operators. For example, the first operators are A1 and A2. A1 computes a×b=n, and operator A2 computes n+c to output the result. Then operator A1 and operator A2 may be fused to obtain operator B1 to compute a×b+c. In this embodiment, the granularity of the second operator fused by the first operators is larger than the granularity of the first operators. For example, the granularity of A1 is 1, and the granularity of A2 is 1, then the granularity of B1 is 2. In an embodiment, the second operator is an addition-multiplication combination operator.

In S230, at least two second operators for computing the same target expression are acquired.

In this embodiment, there are a plurality of target expressions. Each second operator can be used for computing only one target expression. That at least two second operators for computing the same target expression are acquired refers to that the second operators for computing the same target expression are identified. In an embodiment, there are three second operators: B1, B2 and B3. The target expression computed by operator B1 is Y1=a×X+b. The target expression computed by operator B2 is Y2=a×X+c. The target expression computed by operator B3 is Y3=a×X+b. Y1, Y2 and Y3 are output computation results. a, b and c are constants. X is a constant or variable. If the value of X is not input, Xis a variable. If the value of X is input, Xis a constant. Since the target expression computed by operator B1 is the same as the target expression computed by operator B3, operator B1 and operator B3 are acquired. There may also be more operators to compute the same target expression.

In S240, at least two second operators are fused to obtain a third operator.

In this embodiment, at least two second operators for computing the same target expression may be fused. For example, operator B1 and operator B3 compute the same target expression Y=a×X+b. Therefore, operator B1 and operator B3 may be fused to obtain third operator C1 to compute the target expression Y=a×X+b. In this embodiment, the granularity of the third operator is larger than the granularity of the second operators. The granularity of the third operator is determined according to the granularity of the fused second operators. For example, the granularity of each of operator B1 and operator B2 is 2, and the granularity of operator C1 after fusion is 4. The amount of computation of an operator is improved.

In S250, a final data streaming computation graph is obtained based on a non-fused second operator in the target data streaming computation graph and the third operator.

In this embodiment, the second operator without the same target expression cannot be fused, and the granularity of the second operator is retained. The final data streaming computation graph is obtained by the optimization of the target data streaming computation graph. In the final data streaming computation graph, a deep learning architecture is computed by the second operator and/or the third operator.

In this embodiment, the third operator is obtained by the fusion of the second operators with the same target expression. Thus, the granularity of the operator in the data streaming computation graph is increased, and the computation power and computation efficiency of a neural network architecture are improved.

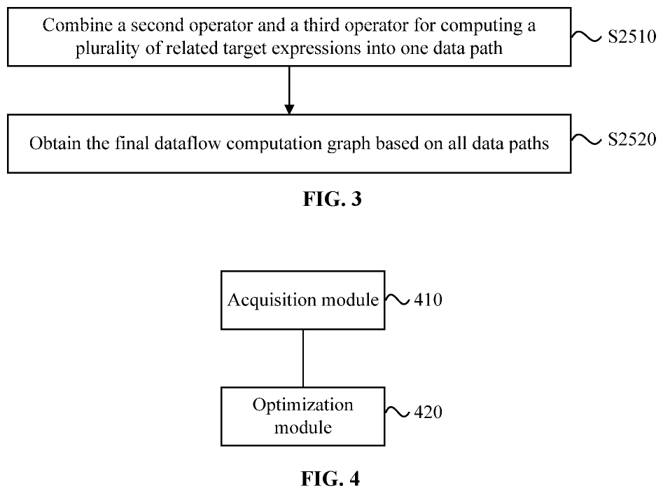

Referring to FIG. 3, in an embodiment, step S250 includes the steps below.

In S2510, the second operator and the third operator for computing a plurality of related target expressions are combined into one data path.

In this embodiment, the term “related” here means that input of the current operator needs to be determined according to an output result of the previous operator and that an output result of the current operator is used as input of the next operator. For example, the target expression computed by the second operator may be Y1=a×X1+c, and the target expression computed by the third operator may be Y2=Y1×X2+d. a, c and d are constants. X1 and X2 are variables. The values of X1 and X2 may be determined only after data is input. Since there is a variable in the target expression computed by the second operator, combination cannot be performed. Moreover, the third operator needs the computation result of the second operator and uses the computation result as data. Therefore, the second operator and the third operator may be combined into one data path. The connection between operators is determined according to the correlation of the target expressions.

In an embodiment, one data path includes a header operator, a successor operator and an output operator. The header operator is used for undertaking initialization of all parameters. The successor operator is used for acquiring the output of a predecessor operator. The output operator is used for outputting data. The head operator refers to a first operator for computation. The output operator refers to an operator for outputting the final result. The successor operator refers to an operator using the computation result of the previous operator as input. The predecessor operator refers to an operator for outputting the result to the next operator. For example, there are four operators A, B, C and D. The computation order is A, B, C and D. Then A is the head operator, D is the output operator, A, B and C are predecessor operators, and B, C and D are successor operators.

In S2520, the final data streaming computation graph is obtained based on all data paths.

In this embodiment, related operators are connected to form one data path, and unrelated operators are not in this data path. Thus, there is at least one data path. All data paths are combined into the final data streaming computation graph to perform the computation of the deep learning network. In an embodiment, an ordering of operators follows an underlying cache design, which greatly reduces the time for the previous operator to input the computation result to the next operator and improves the computation efficiency.

In the scheme of this embodiment of the present application, the initial data streaming computation graph that includes the first operators for computing the initial constant expressions is acquired; and the target data streaming computation graph is obtained according to the parameters in the initial constant expressions. With this scheme, the initial data streaming computation graph is optimized to the target data streaming computation graph. Moreover, the parameter computation of the data streaming computation graph can be completed in one step. Thus, the computation time of the deep learning network is reduced. Additionally, the granularity of the second operator in the target data streaming computation graph is larger than the granularity of the first operator in the initial data streaming computation graph. Therefore, the amount of computation of the second operator in the target data streaming computation graph is also larger, and the technical effect of improving the computation efficiency of the deep learning network is achieved.

### Embodiment Three

FIG. 4 is a diagram illustrating the structure of a device for adjusting a deep learning network according to embodiment three of the present application. This embodiment may be applied to the scenario in which the deep learning network developed based on a data streaming architecture is optimized. This device may be performed by the software and/or hardware and may be integrated on the server.

As shown in FIG. 4, the device for adjusting a deep learning network provided by embodiment three of the present application includes an acquisition module 410 and an adjustment module 420.

The acquisition module 410 is configured to acquire an initial data streaming computation graph that includes first operators for computing initial constant expressions.

The adjustment module 420 is configured to obtain a target data streaming computation graph according to parameters in the initial constant expressions. The target data streaming computation graph includes a second operator and is used for controlling a deep learning acceleration chip to perform the data computation. The granularity of the second operator is larger than the granularity of the first operators to enable an adjustment of the amount of computation of the deep learning acceleration chip.

In an embodiment, the second operator is obtained by fusion of at least two first operators.

In an embodiment, the second operator is used for computing the target expression that is obtained based on the parameters in the initial constant expressions.

In an embodiment, there are a plurality of target expressions and a plurality of second operators. The acquisition module 410 is further configured to acquire at least two second operators for computing the same target expression. The device further includes a fusion module. The fusion module is configured to fuse at least two second operators to obtain the third operator. The final data streaming computation graph is obtained based on the non-fused second operator in the target data streaming computation graph and the third operator.

In an embodiment, the fusion module is configured to obtain the final data streaming computation graph based on the non-fused second operator in the target data streaming computation graph and the third operator in the following manner: combining the second operator and the third operator for computing a plurality of related target expressions into one data path; and obtaining the final data streaming computation graph based on all data paths. The plurality of related target expressions represent that output of an operator for computing one of the plurality of related target expressions is input of an operator for computing another one of the plurality of related target expressions.

In an embodiment, the data path includes a header operator, a successor operator and an output operator. The header operator is used for undertaking initialization of all parameters. The successor operator is used for acquiring output of the predecessor operator. The output operator is used for outputting data.

In an embodiment, the granularity of the third operator is larger than the granularity of the second operator.

The device for adjusting a deep learning network provided in this embodiment of the present application may execute the method for adjusting a deep learning network provided by any embodiment of the present application and has functional modules and beneficial effects corresponding to the method executed. For content not described in detail in this embodiment, reference may be made to description in any method embodiment of the present application.

### Embodiment Four

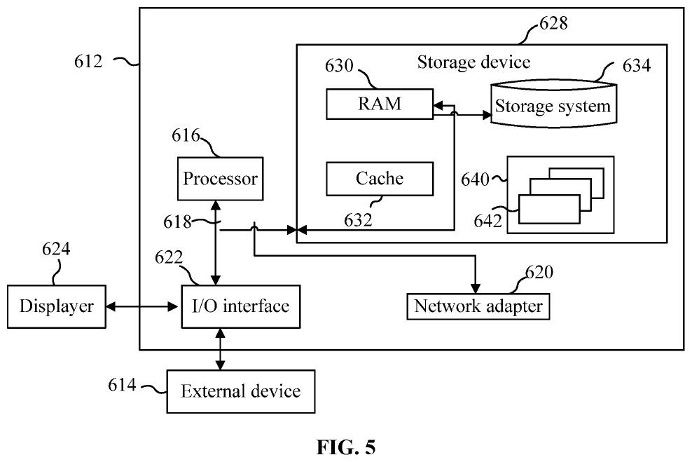

FIG. 5 is a diagram illustrating the structure of a server according to embodiment four of the present application. FIG. 5 is a block diagram of an exemplary server 612 for performing an embodiment of the present application. The server 612 shown in FIG. 5 is merely an example and does not intend to limit the function and use scope of the embodiment of the present application.

As shown in FIG. 5, the server 612 takes the form of a general server. Components of the server 612 may include, but not limited to, one or more processors 616, a storage device 628, and a bus 618 connecting different system components (including the storage device 628 and the one or more processors 616).

The bus 618 represents one or more of several types of bus structures including a storage device bus or a storage device controller, a peripheral bus, a graphics acceleration port, a processor, or a local bus using any one of multiple bus structures. For example, these architectures include, but are not limited to, an industry subversive alliance (ISA) bus, a micro channel architecture (MCA) bus, an enhanced ISA bus, a video electronics standards association (VESA) local bus and a peripheral component interconnect (PCI) bus.

In an embodiment, the server 612 includes a plurality of computer system readable media. These media may be any available medium that can be accessed by the server 612, including volatile and non-volatile media, and removable and non-removable media.

The storage device 628 may include a computer system readable medium in the form of a volatile memory, such as a random access memory (RAM) 630 and/or a cache memory 632. In an embodiment, the terminal 612 may include other removable/non-removable and volatile/non-volatile computer system storage media. By way of example only, a storage system 634 may be configured to read from and write to non-removable and non-volatile magnetic media (not shown in FIG. 5, commonly referred to as a “hard disk drive”). Although not shown in FIG. 5, it is feasible to provide not only a magnetic disk driver configured to perform reading and writing on a removable non-volatile magnetic disk (for example, a “floppy disk”), but also an optical disk driver for performing reading and writing on a removable non-volatile optical disk, such as a compact disc read-only memory (CD-ROM), a digital video disc-read only memory (DVD-ROM) or other optical media. In such instances, each driver may be connected to the bus 618 by one or more data media interfaces. The storage device 628 may include at least one program product having a group of program modules (for example, at least one program module). These program modules are configured to perform functions of the embodiments of the present application.

A program/utility 640 having a group of program modules 642 (at least one program module 642) may be stored in the storage device 628 or the like. Such program modules 642 include, but are not limited to, an operating system, one or more application programs, other program modules and program data. Each or one combination of these examples may include implementation of a network environment. The program modules 642 generally perform functions and/or methods in the embodiments of the present application.

The server 612 may communicate with one or more external devices 614 (for example, a keyboard, a pointing terminal, and a displayer 624). The server 612 may further communicate with one or more terminals that enable a user to interact with the server 612, and/or with any terminal (for example, a network card or a modem) that enables the server 612 to communicate with one or more other computation terminals. Such communication may be performed through an input/output (I/O) interface 622. Moreover, the server 612 may communicate with one or more networks (such as a local area networks (LAN), a wide area networks (WAN) and/or a public network, for example the Internet) through a network adapter 620. As shown in FIG. 5, the network adapter 620 communicates with other modules of the server 612 via the bus 618. Although not shown in FIG. 5, other hardware and/or software modules may be used in conjunction with the server 612. The other hardware and/or software modules include, but are not limited to, microcode, a terminal driver, a redundant processor, an external disk drive array, a redundant arrays of independent disks (RAID) system, a tape driver and a data backup storage system.

The one or more processors 616 execute a program stored in the storage device 628 to perform various functional applications and data processing, for example, to perform the method for adjusting a deep learning network according to any embodiment of the present application. The method includes acquiring the initial data streaming computation graph that includes the first operators for computing the initial constant expressions; and obtaining the target data streaming computation graph according to the parameters in the initial constant expressions. The target data streaming computation graph includes the second operator and is used for controlling the deep learning acceleration chip to perform the data computation. The granularity of the second operator is larger than the granularity of the first operator to enable an adjustment of the amount of computation of the deep learning acceleration chip.

In the scheme of this embodiment of the present application, the initial data streaming computation graph that includes the first operators for computing the initial constant expressions is acquired; and the target data streaming computation graph is obtained according to the parameters in the initial constant expressions. With this scheme, the initial data streaming computation graph is optimized to the target data streaming computation graph. Moreover, the parameter computation of the data streaming computation graph can be completed in one step. Thus, the computation time of the deep learning network is reduced. Additionally, the granularity of the second operator in the target data streaming computation graph is larger than the granularity of the first operator in the initial data streaming computation graph. Therefore, the amount of computation of the second operator in the target data streaming computation graph is also larger, and the technical effect of improving the computation efficiency of the deep learning network is achieved.

### Embodiment Five

Embodiment five of the present application provides a computer-readable storage medium storing a computer program which, when executed by a processor, causes the processor to perform the method for adjusting a deep learning network according to any embodiment of the present application. The method includes acquiring an initial data streaming computation graph that includes first operators for computing initial constant expressions; and obtaining a target data streaming computation graph according to parameters in the initial constant expressions. The target data streaming computation graph includes a second operator and is used for controlling the deep learning acceleration chip to perform the data computation. The granularity of the second operator is larger than the granularity of the first operator to enable an adjustment of the amount of computation of the deep learning acceleration chip.

The computer storage medium in embodiments of the present application may use any combination of one or more computer-readable media. The computer-readable media may be computer-readable signal media or computer-readable storage media. The computer-readable storage medium may be, and not limited to, an electrical, magnetic, optical, electromagnetic, infrared, or semiconductor system, apparatus, or device, or any combination thereof. Examples of the computer-readable storage medium include (non-exhaustive list): an electrical connection having one or more wires, a portable computer magnetic disk, a hard disk, a random-access memory (RAM), a read-only memory (ROM), an erasable programmable read-only memory (EPROM) or flash memory, an optical fiber, a compact disc read-only memory (CD-ROM), an optical memory device, a magnetic memory device, or any suitable combination thereof. In the present application, the computer-readable storage medium may be any tangible medium including or storing a program. The program may be used by or used in conjunction with an instruction execution system, apparatus, or device.

The computer-readable signal medium may include a data signal propagated on a base band or as a part of a carrier wave. The computer-readable signal medium carries computer-readable program codes. The data signal propagated in this manner may be in multiple forms and includes, and is not limited to, an electromagnetic signal, an optical signal, or any suitable combination thereof. The computer-readable signal medium may further be any computer-readable medium other than a computer-readable storage medium. The computer-readable medium may send, propagate, or transmit the program used by or used in conjunction with the instruction execution system, device, or element.

The program code contained on the computer-readable medium may be transmitted on any suitable medium, including, but not limited to, wireless, wire, optical cable, radio frequency (RF), and the like, or any suitable combination thereof.

Computer program codes for performing the operations of the present application may be written in one or more programming languages or a combination thereof, the programming languages including object-oriented programming languages such as Java, Smalltalk, C++ and further including conventional procedural programming languages such as C programming language or similar programming languages. The program codes may be executed entirely or partially on a user computer, as a separate software package, partially on the user computer and partially on a remote computer, or entirely on the remote computer or terminal. In the scenario involving the remote computer, the remote computer may be connected to the user computer through any type of network, including a local area network (LAN) or a wide area network (WAN), or the connection may be made to an external computer (for example, through the Internet using an Internet service provider).

In the scheme of this embodiment of the present application, the initial data streaming computation graph that includes the first operators for computing the initial constant expressions is acquired; and the target data streaming computation graph is obtained according to parameters in the initial constant expressions. With this scheme, the initial data streaming computation graph is optimized to the target data streaming computation graph. Moreover, the parameter computation of the data streaming computation graph can be completed in one step. Thus, the computation time of the deep learning network is reduced. Additionally, the granularity of the second operator in the target data streaming computation graph is larger than the granularity of the first operator in the initial data streaming computation graph. Therefore, the amount of computation of the second operator in the target data streaming computation graph is also larger, and the technical effect of improving the computation efficiency of the deep learning network is achieved.

1. A method for adjusting a deep learning network, comprising:
acquiring an initial data streaming computation graph that comprises first operators for computing initial constant expressions; and
obtaining a target data streaming computation graph according to parameters in the initial constant expressions, wherein the target data streaming computation graph comprises a second operator and is used for controlling a deep learning acceleration chip to perform data computation, and a granularity of the second operator is larger than a granularity of one of the first operators to enable an adjustment of an amount of computation of the deep learning acceleration chip.

2. The method according to claim 1, wherein the second operator is obtained by fusion of at least two of the first operators.

3. The method according to claim 1, wherein the second operator is used for computing a target expression obtained based on the parameters in the initial constant expressions.

4. The method according to claim 3, wherein a plurality of target expressions and a plurality of second operators are configured; and
after obtaining the target data streaming computation graph according to the parameters in the initial constant expressions, the method further comprises:
acquiring, from among the plurality of second operators, at least two second operators for computing a same target expression;
fusing the at least two second operators to obtain a third operator; and
obtaining a final data streaming computation graph based on a non-fused second operator in the target data streaming computation graph and the third operator.

5. The method according to claim 4, wherein at least one non-fused second operator in the target streaming computation graph is configured, and at least one third operator is configured;
obtaining the final data streaming computation graph based on the non-fused second operator in the target data streaming computation graph and the third operator comprises:
combining one of the at least one non-fused second operator and one of the at least one third operator for computing a plurality of related target expressions in the target streaming computation graph into one data path, wherein the plurality of related target expressions represent that output of an operator for computing one of the plurality of related target expressions is input of an operator for computing another one of the plurality of related target expressions; and
obtaining the final data streaming computation graph based on all data paths.

6. The method according to claim 5, wherein the data path comprises a header operator, a successor operator and an output operator, wherein the header operator is used for undertaking initialization of all parameters, the successor operator is used for acquiring output of a predecessor operator, and the output operator is used for outputting data.

7. The method according to claim 4, wherein a granularity of the third operator is larger than the granularity of the second operator.

8. A device for adjusting a deep learning network, comprising:
an acquisition module configured to acquire an initial data streaming computation graph that comprises first operators for computing initial constant expressions; and
an optimization module configured to obtain a target data streaming computation graph according to parameters in the initial constant expressions, wherein the target data streaming computation graph comprises a second operator and is used for controlling a deep learning acceleration chip to perform data computation, and a granularity of the second operator is larger than a granularity of one of the first operators to enable an adjustment of an amount of computation of the deep learning acceleration chip.

9. A server, comprising:
at least one processor; and
a storage device configured to store at least one program,
wherein when executed by the at least one processor, the at least one program causes the at least one processor to perform the following steps:
acquiring an initial streaming computation graph that comprises first operators for computing initial constant expressions; and
obtaining a target streaming computation graph according to parameters in the initial constant expressions, wherein the target streaming computation graph comprises a second operator and is used for controlling a deep learning acceleration chip to perform data computation, and a granularity of the second operator is larger than a granularity of one of the first operators to enable an adjustment of an amount of computation of the deep learning acceleration chip.

10. A non-transitory computer-readable storage medium storing a computer program which, when executed by a processor, causes the processor to perform the method for adjusting a deep learning network according to claim 1.

11. The server according to claim 9, wherein the second operator is obtained by fusion of at least two of the first operators.

12. The server according to claim 9, wherein the second operator is used for computing a target expression obtained based on the parameters in the initial constant expressions.

13. The server according to claim 12, wherein a plurality of target expressions and a plurality of second operators are configured; and
after obtaining the target streaming computation graph according to the parameter in the initial constant expression, the at least one program causes the at least one processor to further perform:
acquiring, from among the plurality of second operators, at least two second operators for computing a same target expression;
fusing the at least two second operators to obtain a third operator; and
obtaining a final streaming computation graph based on a non-fused second operator in the target streaming computation graph and the third operator.

14. The server according to claim 13, wherein at least one non-fused second operator in the target streaming computation graph is configured, and at least one third operator is configured;
wherein the at least one program causes the at least one processor to perform obtaining the final streaming computation graph based on the non-fused second operator in the target streaming computation graph and the third operator by:
combining one of the at least one non-fused second operator and one of the at least one third operator for computing a plurality of related target expressions in the target streaming computation graph into one data path, wherein the plurality of related target expressions represent that output of an operator for computing one of the plurality of related target expressions is input of an operator for computing another one of the plurality of related target expressions; and
obtaining the final streaming computation graph based on all data paths.

15. The server according to claim 14, wherein the data path comprises a header operator, a successor operator and an output operator, wherein the header operator is used for undertaking initialization of all parameters, the successor operator is used for acquiring output of a predecessor operator, and the output operator is used for outputting data.

16. The server according to claim 13, wherein a granularity of the third operator is larger than the granularity of the second operator.

17. The storage medium according to claim 10, wherein the second operator is obtained by fusion of at least two of the first operators, and the second operator is used for computing a target expression obtained based on the parameters in the initial constant expressions.

18. The storage medium according to claim 17, wherein a plurality of target expressions and a plurality of second operators are configured; and
after obtaining the target streaming computation graph according to the parameter in the initial constant expression, the computer program causes the processor to further perform:
acquiring, from among the plurality of second operators, at least two second operators for computing a same target expression;
fusing the at least two second operators to obtain a third operator; and
obtaining a final streaming computation graph based on a non-fused second operator in the target streaming computation graph and the third operator.

19. The storage medium according to claim 18, wherein at least one non-fused second operator in the target streaming computation graph is configured, and at least one third operator is configured;
wherein the computer program causes the processor to perform obtaining the final streaming computation graph based on the non-fused second operator in the target streaming computation graph and the third operator by:
combining one of the at least one non-fused second operator and one of the at least one third operator for computing a plurality of related target expressions in the target streaming computation graph into one data path, wherein the plurality of related target expressions represent that output of an operator for computing one of the plurality of related target expressions is input of an operator for computing another one of the plurality of related target expressions; and
obtaining the final streaming computation graph based on all data paths.

20. The storage medium according to claim 19, wherein the data path comprises a header operator, a successor operator and an output operator, wherein the header operator is used for undertaking initialization of all parameters, the successor operator is used for acquiring output of a predecessor operator, and the output operator is used for outputting data.
